(19) United States
(12) Patent Application Publication
(10) Pub. No.: US 2011/0213098 A1
(43) Pub. Date: Sep. 1, 2011

(54) THERMALLY STABLE ARTICLE AND METHOD OF MANUFACTURE THEREOF

(75) Inventors: Domenico La Camera, Breda (NL); Hendrik Kormelink, Heverlee (BE); Alexis Chopin, St. Maximin (FR); Herve Cartier, Chantilly (FR)

(73) Assignee: SABIC INNOVATIVE PLASTICS IP B.V., Bergen op Zoom (NL)

(21) Appl. No.: 13/038,016

(22) Filed: Mar. 1, 2011

Related U.S. Application Data
(60) Provisional application No. 61/309,239, filed on Mar. 1, 2010.

(51) Int. Cl. C08G 69/48

(52) U.S. Cl. 525/426

(57) ABSTRACT

An article that includes a thermoplastic composition and a crosslinking agent. The crosslinking agent is thermally activated by annealing at a temperature proximate to the flow point of the thermoplastic composition to stabilize the dimensions of the article during service when compared with a similar article that contains the thermoplastic resin without the crosslinking agent or a similar article that contains the crosslinking agent but is thermally activated at a rate of greater than or equal to about 5 degrees centigrade per minute to the same temperature.

### CROSS-REFERENCE TO RELATED APPLICATION

This application claims priority to U.S. Provisional Application having Ser. No. 61/309,239, the entire contents of which are incorporate herein by reference.

### BACKGROUND OF THE INVENTION

This present invention is directed thermally stable articles and methods of manufacture thereof.

Thermoplastic materials are often crosslinked prior to being put into service in order to retain dimensional stability and to withstand temperature increases that lead to degradation. One method of crosslinking these materials is to subject them to radiation. Examples of radiation are gamma radiation, beta radiation, electron beam radiation, x-ray radiation, ultraviolet radiation, or combinations thereof. However, the irradiation process is an additional step that needs to be performed when the thermoplastic part has been molded into a desired final shape. This irradiation process is costly, and the cost is proportional to the irradiation-dose needed.

Another problem that occurs in thermoplastic materials is their inability to maintain mechanical or dimensional stability during storage or during service where elevated temperatures are involved. If the thermoplastic material is stored next to a source of elevated temperature, the temperature of the thermoplastic part is frequently increased. This increase in temperature promotes changes in dimension and shape, which lead to the part not being used for its intended purpose.

The service temperature indicates the ability of the thermoplastic part to retain a certain property when exposed to elevated temperatures for a certain period of time. In some applications, temperatures can sometimes unexpectedly rise during usage. Examples of such applications are frictional applications, electrical applications, welding and soldering applications, and the like.

In frictional applications, for example, the friction drives up the temperature of the thermoplastic part causing it to undergo a change in shape or dimension. If the temperature (as a result of the friction) is higher then the service temperature of the thermoplastic part then a partial or a total deformation of the part can take place, giving rise to mechanical failure and other issues.

Similarly in electrical applications, resistive heating frequently drives up the temperature of the thermoplastic part causing it to undergo a change in shape or dimension. In addition, in electrical applications, the temperature to which a thermoplastic part is exposed can rise far above the service temperature due to, for example, arcing or sparking.

Soldering is a process used to bond electronic chips to a thermoplastic substrate. During soldering, the thermoplastic substrate can deform or give rise to blisters.

Another problem that undermines the use of thermoplastic parts is the degradation of properties due to prolonged periods of thermal aging. Thermoplastics parts tend to lose their mechanical or electrical properties after prolonged periods of thermal aging at relatively high temperatures (temperatures that are generally greater than the glass transition temperature). The ability to retain certain properties when exposed to high temperature is called heat stability of the material.

In view of these deficiencies, it is desirable to have thermoplastic materials and parts that can respond to these increases in temperature at the time of the increase in temperature and that can mitigate the loss of mechanical properties/or can retain mechanical properties when they are being subjected to the increase in temperature.

### SUMMARY OF THE INVENTION

In one embodiment, the present invention is directed to an article comprising a thermoplastic composition; and a crosslinking agent; the crosslinking agent being thermally activated by annealing at a temperature proximate to the flow point of the thermoplastic composition to stabilize the high temperature mechanical properties and/or dimensions of the article when compared with the high temperature mechanical properties and/or dimensions of a similar article that contains the thermoplastic resin without the crosslinking agent.

In another embodiment, the present invention is directed to an article comprising a thermoplastic composition; and a crosslinking agent; the crosslinking agent being thermally activated during service by increasing the temperature of the entire article, or of a certain localized regions of the article, to a temperature of greater than or equal to about 100° C. above the flow point of the thermoplastic composition at a rate greater than or equal to about 5° C. per minute for a time period of less than or equal to about 20 minutes.

In yet another embodiment, the present invention is directed to a method comprising manufacturing an article comprising a thermoplastic composition; and a crosslinking agent; placing the article in service; increasing the temperature of the article to crosslink the article in those regions where the temperature exceeds an activation temperature for the crosslinking agent.

### BRIEF DESCRIPTION OF THE FIGURES

FIG. 1 depicts the storage modulus versus temperature measured on a DMTA on two bars manufactured from the formulation reported in Table 1. Bar 1 was annealed at 240C, while Bar 2 was directly heated up to 300° C. at 5° C./min. The increase in modulus due to annealing at 240° C. can be seen;

FIG. 2 shows the enlargement of recorded storage modulus versus temperature corresponding to the area demarcated by the dotted rectangle in the FIG. 1;

FIG. 3 depicts the storage modulus as a function of time, recorded during the experiment on Bar 1, which is also reported in the FIGS. 1 and 2. The 3 regions relative to temperature increase are from a) 23 to 240° C. at 5° C./minutes b) annealing at 240° C. for 180 minutes, and c) the temperature increase from 240° C. to 300° C. The modulus steadily increases during the annealing at 240° C. for 180 minutes;

FIG. 4 depict the Bar 1 and Bar 2 after DMTA experiment, top and bottom respectively. Both samples have been heated up to 300° C., at 5° C./min. Bar 1 was annealed at 240° C. for 3 hours, while Bar 2 was not annealed. As is apparent, Bar 1 has been slightly deformed by the bending force during the DMTA experiment described above while Bar 2, which was not annealed was drastically deformed;

FIGS. 5A through 5F depict the hot air aging data at temperature in the range of 160 to 210° C. for Formulations I and II; and

FIG. 6 is a graph showing the hot air aging at 200C for Formulation III when e-beam irradiated and non-irradiated.

### DETAILED DESCRIPTION OF THE INVENTION

The present invention is more particularly described in the following description and example that are intended to be illustrative only since numerous modifications and variations therein will be apparent to those skilled in the art. As used in the specification and in the claims, the term “comprising” may include the embodiments “consisting of” and “consisting essentially of.” All ranges disclosed herein are inclusive of the endpoints and are independently combinable. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

Disclosed herein are articles that contain a thermoplastic composition and a crosslinking agent such that the crosslinking of the thermoplastic composition occurs only upon being activated by an increase in temperature above an activation temperature for the thermoplastic composition. The increase in the temperature of the article above the activation temperature promotes crosslinking, which provides thermal stability to those portions of the article that suffer the temperature increase and thus help it retain its dimensional stability by increasing its glass transition temperature. The increase in temperature may occur prior to placement of the article into service, and as such is an alternative to radiation cross-linking. Alternatively, the increase in temperature may occur after the placement of the article into service thereby providing an article that is self-crosslinking, and therefore self-protecting. This method provides an article that avoids the costs associated with an extra crosslinking process while still providing the benefits of crosslinking when needed. Accordingly, the present invention also discloses the use of thermal energy in a process for activating a crosslinking agent.

This process of promoting thermally induced crosslinking primarily in those regions that undergo an increase in temperature facilitates a reduction in the cost of manufacturing such an article. This is primarily because it eliminates the irradiation step normally required to crosslink the entire article. In addition, by introducing the crosslinking agent only into those parts of the article that are exposed to elevated temperatures, material costs may also be reduced by proportionally reducing the amount of the crosslinking agent used in the article.

Thermal crosslinking permits the article to retain its shape and thus enhances dimensional stability above the service temperature. The ability of the material to “respond” by this thermally induced crosslinking prevents the loss of part shape and/or integrity and the possible consequences of part failure. The ability of the material to crosslink when the temperature increases allows the material to “self protect” itself and in turn to improve mechanical properties at elevated temperatures thus maintaining part integrity and improving wear resistance.

Since the glass transition temperature increases with increasing temperature due to an increase in the amount of crosslinking, the gradual crosslinking of the material over time (when subjected to elevated temperatures) permits the material to handle successively higher temperatures as it ages.

In general, crosslinked materials can withstand temperatures that are much greater than the melting temperature of the same material. The novelty of the present invention lies in the fact that at temperatures above the flow point or temperature (i.e., the glass transition temperature in amorphous polymers or semi-crystalline polymers having low levels of crystallinity or the melting temperature in highly crystalline semi-crystalline polymers) the kinetics of thermally induced crosslinking permits the material to crosslink at a rate that is effective to prevent the material from undergoing thermally induced deformation, thus permitting the article to retain its shape and dimensions. It is therefore desirable to add the crosslinking agent to polymers that are below their glass transition temperatures or below their flow point.

The thermoplastic composition comprises thermoplastic organic polymers. The thermoplastic organic polymer can comprise a small amount of a thermosetting polymer. The thermoplastic organic polymer can be a homopolymer, a copolymer, a block copolymer, an alternating copolymer, an alternating block copolymer, a random copolymer, a random block copolymer, a graft copolymer, a star block copolymer, an ionomer, a dendrimer, or a combination comprising at least one of the foregoing polymers. An exemplary thermoplastic polymer is a polyamide.

Examples of thermoplastic polymers are polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, styrene acrylonitrile, acrylonitrile-butadiene-styrene (ABS), polyethylene terephthalate, polybutylene terephthalate, polyurethane, ethylene propylene diene rubber (EPR), polytetrafluoroethylene, fluorinated ethylene propylene, perfluoroalkoxyethylene, polychlorotrifluoroethylene, polyvinylidene fluoride, polysiloxanes, or the like, or a combination comprising at least one of the foregoing organic polymers.

Examples of blends of thermoplastic polymers include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleicanhydride/acrylonitrile-butadiene-styrene, polyether etherketone/polyethersulfone, polyether etherketone/polyetherimide polyethylene/nylon, polyethylene/polyacetal, or the like.

As noted above, an exemplary thermoplastic composition comprises a polyamide. Polyamides are also known as nylons. Polyamides are characterized by the presence of an amide group (—C(O)NH—). In one embodiment, the polyamides can be synthesized by several methods, including the polymerization of a monoamino monocarboxylic acid or a lactam having at least 2 carbon atoms between the amino group and the carboxylic acid group. In another embodiment, the polyamides can be synthesized by the polymerization of substantially equimolar proportions of a diamine, which contains at least 2 carbon atoms between the amino groups and a dicarboxylic acid. In yet another embodiment, the polyamides can be synthesized by the polymerization of a monoaminocarboxylic acid or a lactam, together with substantially equimolar proportions of a diamine and a dicarboxylic acid. The dicarboxylic acid can be used in the form of a functional derivative thereof, for example, a salt, an ester or an acid chloride. Polyamides are also commercially available from a wide variety of sources.

Nylon-6, for example, is a polymerization product of caprolactam. Nylon-6,6 is a condensation product of adipic acid and 1,6-diaminohexane. Likewise, nylon-4,6 is a condensation product between adipic acid and 1,4-diaminobutane. Besides adipic acid, other useful diacids for the preparation of nylons include azelaic acid, sebacic acid, dodecane diacid, as well as terephthalic and isophthalic acids, and the like. Other useful diamines include diamino m-xylene, di-(4-aminophenyl) methane, di-(4-aminocyclohexyl) methane, 2,2-di-(4-aminophenyl) propane, 2,2-di-(4-aminocyclohexyl) propane, among others.

Exemplary polyamides comprise polypyrrolidone (nylon-4), polycaprolactam (nylon-6), polycapryllactam (nylon-8), polyhexamethylene adipamide (nylon-6,6), polyundecano lactam (nylon-11), polydodecanolactam (nylon-12), polyhexamethylene azelaiamide (nylon-6,9), polyhexamethylene, sebacamide (nylon-6,10), polyhexamethylene isophthalamide (nylon-6,I), polyhexamethylene terephthalamide (nylon-6,T), polyamide of hexamethylene diamine and n-dodecanedioic acid (nylon-6,12), as well as polyamides resulting from terephthalic acid and/or isophthalic acid and trimethyl hexamethylene diamine, polyamides resulting from adipic acid and meta xylenediamines, polyamides resulting from adipic acid, azelaic acid and 2,2-bis-(p-aminocyclohexyl)propane, polyamides resulting from terephthalic acid and 4,4′-diamino-dicyclohexylmethane, or the like, or combinations comprising one at least one of the foregoing polyamides. The thermoplastic composition may also comprise two or more polyamides. For example the thermoplastic composition may comprise nylon-6 and nylon-6,6.

Copolymers of the foregoing polyamides are also suitable for use in the practice of the present disclosure. Exemplary polyamide copolymers comprise copolymers of hexamethylene adipamide/caprolactam (nylon-6,6/6), copolymers of caproamide/undecamide (nylon-6/11), copolymers of capro amide/dodecamide (nylon-6/12), copolymers of hexamethylene adipamide/hexamethylene isophthalamide (nylon-6,6/6,I), copolymers of hexamethylene adipamide/hexamethylene terephthalamide (nylon-6,6/6,T), copolymers of hexamethylene adipamide/hexamethylene azelaiamide (nylon-6,6/6,9), or the like, or a combination comprising at least one of the foregoing polyamide copolymers.

Polyamides, as used herein, also comprise the toughened or super tough polyamides. Generally, these super tough nylons are prepared by blending one or more polyamides with one or more polymeric or copolymeric elastomeric toughening agents. Suitable toughening agents can be straight chain or branched as well as graft polymers and copolymers, including core-shell graft copolymers, and are characterized as having incorporated therein either by copolymerization or by grafting on the preformed polymer, a monomer having functional and/or active or highly polar groupings capable of interacting with or adhering to the polyamide matrix so as to enhance the toughness of the polyamide polymer.

In one embodiment, polyamides used in the flame-retardant thermoplastic composition have an intrinsic viscosity of up to about 4 deciliters per gram (dl/g) can be used, or, more specifically, having a viscosity of about 0.2 to about 3.5 dl/g, or, even more specifically, having a viscosity of about 1.0 to about 2.4 dl/g, as measured in a 0.5 wt % solution in 96 wt % sulfuric acid in accordance with ISO 307.

In one embodiment, the polyamide comprises a polyamide having an amine end group concentration greater than or equal to 35 microequivalents amine end group per gram of polyamide (μeq/g) as determined by titration with HCl. Within this range, the amine end group concentration may be greater than or equal to 40 μeq/g, or, more specifically, greater than or equal to 45 μeq/g. The maximum amount of amine end groups is determined by the polymerization conditions and molecular weight of the polyamide. Amine end group content can be determined by dissolving the polyamide in a suitable solvent, optionally with heat. The polyamide solution is titrated with 0.01N hydrochloric acid (HCl) solution using a suitable indication method. The amount of amine end groups is calculated based upon the volume of HCl solution added to the sample, the volume of HCl used for the blank, the molarity of the HCl solution and the weight of the polyamide sample.

The thermoplastic composition comprises polyamide in an amount sufficient to form a continuous phase or co-continuous phase of the flame-retardant thermoplastic composition. The amount of polyamide can be about 30 to about 98 weight percent, more specifically about 50 to about 95 weight percent, even more specifically about 60 to about 90 weight percent of the total weight of the flame-retardant thermoplastic composition.

The thermoplastic polymer can be present in the thermoplastic composition in an amount of about 30 to about 99.9 weight percent (wt %), specifically about 40 to about 90 wt %, and more specifically about 50 to about 85 wt %, based on the total weight of the thermoplastic composition.

The composition further comprises a crosslinking agent capable of crosslinking the polymer chains to produce a crosslinked thermoplastic polymer. Suitable crosslinking agents include those that can form free radicals under beta or gamma radiation.

The crosslinking agents can contain two or more unsaturated groups including olefin groups. Suitable unsaturated groups include acryloyl, methacryloyl, vinyl, allyl, and the like. Exemplary allylic compounds useful as crosslinking agents include those compounds comprising two or more allylic groups, for example, 1,3,5 triazine derivatives—such as for example 1,3,5-triazine, 2,4,6-tris(2-propenyloxy) (TAC), 1,3,5-triazine-2,4,6(1H,3H,5H)-trione, 1,3,5-tri-2-propenyl (TAIC), 1,3,5-tris-(2methyl-propenyl)-s-triazine-2,4,6(1H,3H,5H)-trione (commercially knows as TAICROS M).

As used herein, “(meth)acryloyl” is inclusive of both acryloyl and methacryloyl functionality. The crosslinking agents can include polyol poly(meth)acrylates, which are typically prepared from aliphatic diols, triols and/or tetraols containing about 2 to about 100 carbon atoms. Examples of suitable polyol poly(meth)acrylates include ethyleneglycol diacrylate, 1,6-hexanediol diacrylate, neopentylglycol di(meth)acrylate, ethyleneglycol dimethacrylate (EDMA), polyethyleneglycol di(meth)acrylates, polypropyleneglycol di(meth)acrylates, polybutyleneglycol di(meth)acrylates, 2,2-bis(4-(meth)acryloxyethoxyphenyl) propane, 2,2-bis(4-(meth)acryloxydiethoxyphenyl) propane, pentaerythritol tri(meth)acrylate, pentaerythritol tetra(meth)acrylate, dipentaerythritol penta(meth)acrylate, dipentaerythritol hexa(meth)acrylate, trimethylolpropane trimethacrylate, trimethylolpropane triacrylate (TMPTA), di(trimethylolpropane) tetra(meth)acrylate, and the like, and combinations thereof. Also included are N,N′-alkylenebisacrylamides.

Examples of other crosslinking agents are isocyanate crosslinking agents, polyaldehyde crosslinking agents, phosphine crosslinking agents, epoxy crosslinking agents, triazine crosslinking agents, phosphine crosslinking agents, or a combination comprising at least one of the foregoing crosslinking agents.

Suitable isocyanate crosslinking agents are monomeric or oligimeric molecules having 2 or more isocyanate (—N═C═O) groups. In general, the —N═C═O groups will crosslink the polyamide between both hydroxyl (—OH) groups and amino (—NH₂ or —NH—) groups on the thermoplastic polymer.

Polyisocyanate compounds useful for crosslinking polyamides include aliphatic and aromatic isocyanate compounds having an isocyanate functionality of at least 2. The polyisocyanate compounds can also contain other substituents which do not substantially adversely affect the reactivity of the —N═C═O groups during the crosslinking of polyamides. The polyisocyanate compound can also comprise mixtures of both aromatic and aliphatic isocyanates and isocyanate compounds having both aliphatic and aromatic character. Examples of polyisocyanate crosslinking agents include ethylene diisocyanate, ethylidene diisocyanate, propylene diisocyanate, butylene diisocyanate, hexamethylene diisocyanate, toluene diisocyanate, cyclopentylene-1,3,-diisocyanate, cyclohexylene-1,4-diisocyanate, cyclohexylene-1,2-diisocyanate, 4,4′-diphenylmethane diisocyanate, 2,2-diphenylpropane4,4′-diisocyanate, p-phenylene diisocyanate, m-phenylene diisocyanate, xylylene diisocyanate, 1,4-naphthalene diisocyanate, 1,5-naphthalene diisocyanate, diphenyl4,4′-diisocyanate, azobenzene4,41-diisocyanate, diphenylsulphone4,4′-diisocyanate, dichlorohexamethylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, tetramethylxylene diisocyanate, poly((phenylisocyanate)-co-formaldehyde) and mixtures thereof.

Suitable polyaldehyde crosslinking agents are monomeric or oligimeric molecules having 2 or more —CHO groups. Typically, the —CHO groups will crosslink the polyamide between amino groups on the polyamide. Polyaldehyde compounds useful for crosslinking polyamides include aliphatic and aromatic polyaldehyde compounds having a polyaldehyde functionality of at least 2. The polyaldehyde compounds can also contain other substituents which do not substantially adversely affect the reactivity of the —CHO groups during crosslinking of polyamides. The polyaldehyde compound can also comprise mixtures of both aromatic and aliphatic polyaldehydes and polyaldehyde compounds having both aliphatic and aromatic character. Examples of polyaldehyde crosslinking agents include glutaraldehyde, glyoxal, succinaldehyde, 2,6-pyridenedicarboxaldehyde, and 3-methyl glutaraldehyde.

It has also been discovered that polyamides can be crosslinked using a phosphine crosslinking agent having the general formula (A)₂P(B) and mixtures thereof, wherein A is hydroxyalkyl, and B is hydroxyalkyl, alkyl, or aryl. The A groups will crosslink the polyamide between amino groups on the polyamide to form a Mannich base type linkage —NH—CH₂—PRR₁, where R and R₁ are selected from hydroxy, methyl, hydroxyalkyl, alkyl and aryl groups.

Examples of phosphine crosslinking agents include tris(hydroxymethyl) phosphine, tris(1-hydroxyethyl)phosphine, tris(1-hydroxypropyl)phosphine, bis(hydroxymethyl)-alkylphosphine, and bis(hydroxymethyl)-arylphospine. The amount of phosphine crosslinking agent and the amount of polyamide used in the crosslinking process can be varied depending upon the particular crosslinking agent utilized, the reaction conditions and the particular product application contemplated. Typically, the ratio of A groups in the phosphine crosslinking agent to the total of amount of amino groups in the polyamide can be varied to achieve a predetermined level of crosslinking.

Thermoplastic polymers can be crosslinked using an epoxy crosslinking agent selected from epoxy resins having more than one epoxide group per molecule and mixtures thereof. An exemplary epoxy crosslinking agent is selected from the group consisting of epoxy resins having end groups of the formula (1):

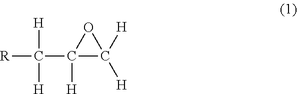

the end groups being directly attached to atoms of carbon, oxygen, nitrogen, sulfur or phosphorus, and mixtures thereof. For example, R may be bisphenol-A. In one embodiment, the epoxy crosslinking agent will crosslink a polyamide between amino groups on the polyamide.

The crosslinks are formed by attack at the epoxide rings by the amine proton, which opens the epoxide ring forming an —OH group and forming a covalent crosslink between the amine (or amide) and the terminal epoxide carbon. Examples of epoxy crosslinking agents include polyglycidyl ethers obtainable by reaction of a compound containing at least two free alcoholic hydroxyl and/or phenolic hydroxyl groups per molecule with epichlorohydrin under alkaline conditions. These polyglycidyl ethers may be made from acyclic alcohols, such as ethylene glycol, diethylene glycol, and higher poly(oxyethylene) glycols; from cycloaliphatic alcohols, such as cyclohexanol and 1,2-cyclohexanediol; from alcohols having aromatic nuclei, such as N,N-bis(2-hydroxyethyl)aniline; from mononuclear phenols, such as resorcinol and hydroquinone; and from polynuclear phenols, such as bis(4-hydroxyphenyl)methane, 4,4′-dihydroxydiphenyl, bis(4-hydroxyphenyl) sulphone, 1,1,2,2-tetrakis(4-hydroxyphenyl)ethane, and 2,2,-bis(4-hydroxyphenyl)propane (otherwise known as bisphenol A). Most preferably, the epoxy crosslinking agent is a bisphenol-A glycidyl ether terminated resin.

Another example of a suitable crosslinking group is an ethynyl group, such as those of the formula —(R)ₐ—C≡C—R′ wherein R is

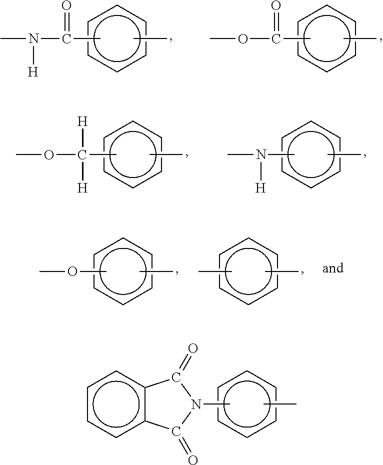

a is an integer of 0 or 1, and R′ is a hydrogen atom or a phenyl group, ethylenic linkage-containing groups, such as allyl groups, including those of the formula

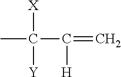

wherein X and Y each, independently of the other, are hydrogen atoms or halogen atoms, such as fluorine, chlorine, bromine, or iodine, vinyl groups, including those of the formula

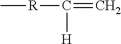

wherein R is an alkyl group, including both saturated, unsaturated, linear, branched, and cyclic alkyl groups, preferably with from 1 to about 30 carbon atoms, more preferably with from 1 to about 11 carbon atoms, even more preferably with from 1 to about 5 carbon atoms, a substituted alkyl group, an aryl group, preferably with from 6 to about 24 carbon atoms, more preferably with from 6 to about 18 carbon atoms, a substituted aryl group, an arylalkyl group, preferably with from 7 to about 30 carbon atoms, more preferably with from 7 to about 19 carbon atoms, or a substituted arylalkyl group, wherein the substituents on the substituted alkyl groups, substituted aryl groups, substituted arylalkyl groups, substituted alkoxy groups, substituted aryloxy groups, and substituted arylalkyloxy groups can be (but are not limited to) hydroxy groups, amine groups, imine groups, ammonium groups, pyridine groups, pyridinium groups, ether groups, aldehyde groups, ketone groups, ester groups, amide groups, carboxylic acid groups, carbonyl groups, thiocarbonyl groups, sulfate groups, sulfonate groups, sulfide groups, sulfoxide groups, phosphine groups, phosphonium groups, phosphate groups, cyano groups, nitrile groups, mercapto groups, nitroso groups, halogen atoms, nitro groups, sulfone groups, acyl groups, acid anhydride groups, azide groups, mixtures thereof, and the like, wherein any two or more substituents can be joined together to form a ring, vinyl ether groups, such as those of the formula

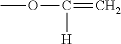

epoxy groups, including those of the formula

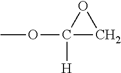

R is an alkyl group, including both saturated, unsaturated, linear, branched, and cyclic alkyl groups, preferably with from 1 to about 30 carbon atoms, more preferably with from 1 to about 11 carbon atoms, even more preferably with from 1 to about 5 carbon atoms, a substituted alkyl group, an aryl group, preferably with from 6 to about 24 carbon atoms, more preferably with from 6 to about 18 carbon atoms, a substituted aryl group, an arylalkyl group, preferably with from 7 to about 30 carbon atoms, more preferably with from 7 to about 19 carbon atoms, or a substituted arylalkyl group, wherein the substituents on the substituted alkyl groups, substituted aryl groups, substituted arylalkyl groups, substituted alkoxy groups, substituted aryloxy groups, and substituted arylalkyloxy groups can be (but are not limited to) hydroxy groups, amine groups, imine groups, ammonium groups, pyridine groups, pyridinium groups, ether groups, aldehyde groups, ketone groups, ester groups, amide groups, carboxylic acid groups, carbonyl groups, thiocarbonyl groups, sulfate groups, sulfonate groups, sulfide groups, sulfoxide groups, phosphine groups, phosphonium groups, phosphate groups, cyano groups, nitrile groups, mercapto groups, nitroso groups, halogen atoms, nitro groups, sulfone groups, acyl groups, acid anhydride groups, azide groups, mixtures thereof, and the like, wherein any two or more substituents can be joined together to form a ring, halomethyl groups, such as fluoromethyl groups, chloromethyl groups, bromomethyl groups, and iodomethyl groups, hydroxymethyl groups, benzocyclobutene groups, including those of the formula

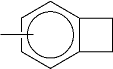

phenolic groups (-φ-OH), provided that the phenolic groups are present in combination with either halomethyl groups or hydroxymethyl groups; the halomethyl groups or hydroxymethyl groups can be present on the same polymer bearing the phenolic groups or on a different polymer, or on a monomeric species present with the phenolic group substituted polymer; maleimide groups, such as those of the formula

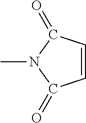

biphenylene groups, such as those of the formula

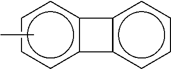

5-norbornene-2,3-dicarboximido (nadimido) groups, such as those of the formula

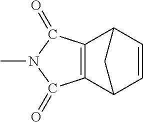

alkylcarboxylate groups, such as those of the formula

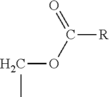

wherein R is an alkyl group (including saturated, unsaturated, and cyclic alkyl groups), preferably with from 1 to about 30 carbon atoms, more preferably with from 1 to about 6 carbon atoms, a substituted alkyl group, an aryl group, preferably with from 6 to about 30 carbon atoms, more preferably with from 1 to about 2 carbon atoms, a substituted aryl group, an arylalkyl group, preferably with from 7 to about 35 carbon atoms, more preferably with from 7 to about 15 carbon atoms, or a substituted arylalkyl group, wherein the substituents on the substituted alkyl, aryl, and arylalkyl groups can be (but are not limited to) alkoxy groups, preferably with from 1 to about 6 carbon atoms, aryloxy groups, preferably with from 6 to about 24 carbon atoms, arylalkyloxy groups, preferably with from 7 to about 30 carbon atoms, hydroxy groups, amine groups, imine groups, ammonium groups, pyridine groups, pyridinium groups, ether groups, ester groups, amide groups, carbonyl groups, thiocarbonyl groups, sulfate groups, sulfonate groups, sulfide groups, sulfoxide groups, phosphine groups, phosphonium groups, phosphate groups, mercapto groups, nitroso groups, sulfone groups, acyl groups, acid anhydride groups, azide groups, and the like, wherein two or more substituents can be joined together to form a ring, and the like. Specific examples include, but are not limited to, 4-(phenylethynyl) phthalic anhydride (4-PEPA) and 4-ethynyl-phthalic anhydride (4-EPA).

The amount of crosslinking agent present in the thermoplastic composition may be about 0.01 to about 20 weight percent, more specifically about 0.1 to about 15 weight percent, even more specifically about 1 to about 10 weight percent, or yet more specifically about 2, about 3, about 4, about 5 or about 6 to about 7 weight percent based on the total weight of the composition.

The thermoplastic composition comprising the thermoplastic polymer and the crosslinking agent may also contain additives such as mold release agents, antioxidants, antiozonants, reinforcing fillers, antistatic agents, electrostatic agents, electrically conducting fillers, thermal stabilizers, and the like.

The manufacturing of the thermoplastic article can be achieved by blending the thermoplastic composition and the crosslinking agent under conditions that produce an intimate blend while not activating the crosslinking reaction. All of the ingredients can be added initially to the processing system, or else certain additives can be precompounded with one or more of the primary components.

In one embodiment, the thermoplastic article is manufactured by blending the thermoplastic composition with the crosslinking agent. The blending can be dry blending, melt blending, solution blending or a combination comprising at least one of the foregoing forms of blending.

In one embodiment, the thermoplastic composition and the crosslinking agent can be dry blended to form a mixture in a device such as a Henschel mixer or a Waring blender prior to being fed to an extruder, where the mixture is melt blended. In another embodiment, a portion of the thermoplastic composition can be premixed with the crosslinking agent to form a dry preblend. The dry preblend is then melt blended with the remainder of the thermoplastic composition in an extruder. In one embodiment, some of the thermoplastic composition can be fed initially at the mouth of the extruder while the remaining portion of the thermoplastic composition is fed through a port downstream of the mouth.

Blending of the composition involves the use of shear force, extensional force, compressive force, ultrasonic energy, electromagnetic energy, thermal energy or combinations comprising at least one of the foregoing forces or forms of energy and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, rolls, rams, helical rotors, or combinations comprising at least one of the foregoing.

Blending involving the aforementioned forces may be conducted in machines such as single or multiple screw extruders, Buss kneader, Henschel, helicones, Ross mixer, Banbury, roll mills, molding machines such as injection molding machines, vacuum forming machines, blow molding machine, or then like, or combinations comprising at least one of the foregoing machines.

The crosslinking agent can be introduced into the melt blending device in the form of a masterbatch. In such a process, the masterbatch may be introduced into the blending device downstream of the point where the thermoplastic composition is introduced.

The melt blending is generally conducted at a temperature that is below the activation temperature of the crosslinking agent or above the activation temperature but for a time that is much shorter than the minimum time necessary to allow the crosslinking reaction to take place. In one embodiment, it is desirable for the crosslinking agent to have an activation temperature that is at or around the glass transition temperature of the thermoplastic composition.

In one embodiment, the thermoplastic composition along with the crosslinking agent dispersed therein is used to prepare molded articles such as for example, durable articles, electrical and electronic components, automotive parts, articles that are used in frictional and tribological applications, and the like. The compositions can be converted to articles using common thermoplastic processes such as film and sheet extrusion, injection molding, gas-assisted injection molding, extrusion molding, compression molding and blow molding.

In one embodiment, the article upon being subjected to an elevated temperature undergoes crosslinking. The crosslinking permits the article to retain its mechanical properties and/or dimensional stability. The presence of the crosslinking agent thus enhances heat resistance, making thermoxidative degradation slower.

In one embodiment, the article is subjected to an elevated temperature prior to placing the article into service. In this embodiment, the article is heated to a temperature above the activation temperature of the crosslinking agent for a sufficient time to allow the crosslinking reaction to start. This heating or annealing step then results in crosslinking of the article. The heating may be done by raising the article to an activation temperature and then holding it steady at this temperature or by gradually increasing the annealing temperature.

In an alternative embodiment, the article is subjected to an elevated temperature after placement of the article into service, thereby resulting in an article that will crosslink only in those areas which reach a temperature above the activation temperature of the crosslinking agent. The ability of the material to “respond” by this thermally induced crosslinking increases the modulus of the polymer and in turn prevent the loss of part shape and/or integrity and the damage to equipment as a result of the decrease of mechanical properties and dimensional stability. The ability of the material to crosslink when the temperature increases will allow the material to “self protect” itself and in turn to improve mechanical properties at elevated temperatures thus maintaining part integrity, and improving wear, all while avoiding a pre-treatment step, which saves time and money in manufacture of the article.

Thus an article containing the thermoplastic composition and the crosslinking agent can be heated gradually at a rate of less than or equal to about 20° C. per minute above the glass transition temperature, specifically at a rate of less than or equal to about 15° C. per minute above the glass transition temperature, specifically at a rate of less than or equal to about 10° C. per minute above the glass transition temperature, and more specifically at a rate of less than or equal to about 5° C. per minute above the glass transition temperature of the thermoplastic composition to a temperature below the degradation point of the thermoplastic composition to produce crosslinking of the article and in turn dimensional stability in the article. It is to be noted that this gradual heating is conducted while the article is in service and happens primarily because the service conditions impose these temperatures on the article.

In yet another embodiment, the article comprising the thermoplastic resin and the crosslinking agent may be molded into the desired shape at a temperature that is greater than or equal to about the activation temperature for the crosslinking The article is then ejected from the mold and allowed to cool at room temperature or cool in an oven at a temperature that is far below the activation temperature. The gradual cooling at lower temperatures allows some additional crosslinking to take place thus imparting some additional dimensional stability and mechanical stability to the article. Thus the partially crosslinked article may be put into service providing the part with an improved service life.

In another embodiment, an article containing the thermoplastic composition and the crosslinking agent can be formed in a process wherein the article is heated gradually at a rate of less than or equal to about 20° C. per minute above the melting temperature, specifically at a rate of less than or equal to about 15° C. per minute above the melting temperature, specifically at a rate of less than or equal to about 10° C. per minute above the melting temperature, and more specifically at a rate of less than or equal to about 5° C. per minute above the melting temperature of the thermoplastic composition to a temperature below the degradation point of the thermoplastic composition to produce dimensional stability in the article.

In another embodiment, the article containing the thermoplastic composition and the crosslinking can be formed in a process wherein the article is heated rapidly to a temperature that is significantly higher than the flow point of the thermoplastic composition for a short period of time. The rapid increase in temperature activates the crosslinking agent and causes the thermoplastic composition to undergo crosslinking thus improving its dimensional stability and mechanical properties. In one embodiment, the article may be exposed to temperatures greater than or equal to about the degradation point for short periods of time to activate the crosslinking agent thereby improving its dimensional stability and its mechanical properties.

In one embodiment, the article is exposed to a temperature of greater than or equal to about 400° C., specifically greater than or equal to about 500° C., specifically greater than or equal to about 600° C., specifically greater than or equal to about 800° C. for a time period of less than or equal to about 5 minutes, specifically less than or equal to about 3 minutes, specifically less than or equal to about 2 minutes, and more specifically less than or equal to about 1 minute in order to produce an article having superior dimensional stability and mechanical properties than an article comprising the same thermoplastic composition and no crosslinking agent. After heating the sample may be cooled back to room temperature or to a desired intermediate temperature where it can be subjected to annealing.

In one embodiment, the article comprising the thermoplastic composition and the crosslinking agent is annealed at a temperature between the glass transition temperature and the melting point displays improved heat stability and thermal oxidative stability over a similar thermoplastic composition that does not contain the crosslinking agent. The improvement in heat stability and thermal oxidative stability are due to crosslinking of the article.

In another embodiment, the article is exposed to a temperature that is greater than or equal to about 100° C. above the flow point, specifically greater than or equal to about 200° C. above the flow point and more specifically greater than or equal to about 300° C. above the flow point for a time period of less than or equal to about 5 minutes, specifically less than or equal to about 3 minutes, and more specifically less than or equal to about 2 minutes in order to produce an article having superior dimensional stability and mechanical properties than an article comprising the same thermoplastic composition and no crosslinking agent. The rate of temperature increase to the temperature above the flow point is at least greater than or equal to about 5° C. per minute, specifically greater than or equal to about 10° C. per minute and more specifically greater than or equal to about 20° C. per minute.

In one embodiment, an article comprising the thermoplastic composition and the crosslinking agent when heated to a first temperature within about 20 to about 40° C. above of flow point (i.e., the first temperature is equal to the flow point ±20° C.) at a rate of about 2 to about 10° C. per minute, annealed at the first temperature for a period of about 1 to about 5 hours and heated to a second temperature of about 50 to about 100° C. above the flow point displays an improved dynamic elastic modulus when compared with a comparative sample having the same thermoplastic composition and crosslinking agent that is not subjected to annealing. The annealed article is also superior to the article that does not contain the crosslinking agent. In one embodiment, the improved dynamic elastic modulus is witnessed above the flow point due to the crosslinking of the article.

In one embodiment, the incorporation of a crosslinking agent into the thermoplastic composition (without irradiating the thermoplastic composition) increases the mechanical stability of the article. For example, the article displays an increase in the dynamic storage modulus of greater than or equal to about 10%, specifically greater than or equal to about 20%, and more specifically greater than or equal to about 50% over another article containing the similar thermoplastic composition that does not contain the crosslinking agent when both articles are subjected to the same level of temperature and stress or strain. The dynamic storage modulus is measured with a Dynamic Mechanical Thermal Analyzer (DMTA), in bending mode, 3 point bending, at a frequency of 1 Hz, clamp mass 20 grams, sample size 50 mm×9.9 mm×3.9 mm.

In yet another embodiment, the article displays a time period for 50% retention in tensile strength after being exposed to a temperature of about 160° C. that is greater than or equal to about 5,500 hours, specifically greater than or equal to about 5,750 hours, and more specifically greater than or equal to about 6,000 hours. The term “time period for 50% retention in tensile strength” is the time taken by a sample to reach 50% of the tensile strength measured at room temperature when the sample is subjected to aging at an elevated temperature. In yet another embodiment, the article displays a time period for 50% retention in tensile strength after being exposed to a temperature of about 180° C. that is greater than or equal to about 2,000 hours, specifically greater than or equal to about 2,150 hours, and more specifically greater than or equal to about 2,400 hours. In yet another embodiment, the article displays a time period for 50% retention in tensile strength after being exposed to a temperature of about 200° C. that is greater than or equal to about 1,400 hours, specifically greater than or equal to about 1,450 hours, and more specifically greater than or equal to about 1,475 hours.

Articles manufactured from the thermoplastic composition and the crosslinking agent can be used in building and construction and in other outdoor applications where structural properties are important. The articles can be used in frictional applications, electrical applications where resistive heating is likely to occur or where arcing occurs or thermal applications where the article is exposed to thermal conduction or convection. It can be also used in vehicles, locomotives, parts of airships, and in other applications that are subjected to elevated temperatures. The article can also be used in applications where it is exposed to electromagnetic radiation that causes heating such as infrared radiation, ultraviolet radiation, visible radiation, or a combination comprising at least one of the foregoing forms of radiation. In particular, the article is not subjected to only ultraviolet radiation during service. Solar radiation, which is known to heat objects can be one of the primary means of activating crosslinking. As noted above, the primary means of bringing about crosslinking is thermal heating not crosslinking by irradiation.

The aforementioned method of manufacturing an article comprising the crosslinking agent with a thermoplastic composition without irradiating the article permits the disposition of the crosslinking agent in only those parts of the article that are submitted to higher service temperatures and are therefore likely to otherwise be deformed. In one embodiment, an article comprises a first part that comprises a first thermoplastic resin and a second part that comprises a second thermoplastic resin and the crosslinking agent. The second part is disposed in those parts of the article that are known to encounter high service temperatures during usage. As a result of this arrangement, only the second part undergoes crosslinking during service upon encountering an elevated temperature, thus enabling the article to maintain dimensional and mechanical stability, while the first part does not undergo any chemical, dimensional or thermal changes since it does not encounter elevated temperatures.

In this manner, a plurality of parts of an article that are known to encounter elevated temperatures may contain the crosslinking agent while other parts may not contain the crosslinking agent. This enables the entire article to be less expensive and to provide the user with a longer service life than an article having the same thermoplastic composition but which does not contain the crosslinking agent.

The following examples, which are meant to be exemplary, not limiting, illustrate compositions and methods of manufacturing of some of the various embodiments of the articles described herein.

### EXAMPLES

### Example 1

This example was conducted to demonstrate the use of crosslinking in polyamides and its role in preventing deformation at elevated temperatures. The polyamide used was polyamide 6,6 commercially available as TECHNYL 27AE1. The crosslinking agent was 1,3,5-tri-2-propenyl (also known as TAIC). Other ingredients in the composition are disclosed in the Table 1 below.

TABLE 1

| Composition | Wt % |
|---|---|
| Nylon 6,6 | 94.8 |
| 1,3,5-tri-2-propenyl | 5 |
| Irganox | 0.05 |
| Irgaphos 168 | 0.05 |
| Stearate De Soude | 0.1 |

Part of the triallyl-isocyanurate (TAIC) can evaporate during melt mixing at 270 to 290° C. Therefore the amount of TAIC was measured in the final molded part. The amount of triallyl-isocyanurate (TAIC) measured on the extruded pellets was 1.97 wt %. Molded bars (dimension 81×40.7×4 mm) manufactured via injection molding showed an amount of TAIC 1.63 wt %. The parts were not irradiated.

The following experiments were performed on a Dynamic Mechanical Thermal Analysis (DMTA), in bending mode, at a frequency of 1 Hz. One molded bar, (hereinafter called Bar 1) was subjected to following temperature cycle during the DMTA scan:

a) the temperature was increased from 25 to 240° C., at a rate of 5° C. per minute;

b) the bar was annealed at 240° C. for 180 minutes; and

c) the temperature was increased from 240 to 300° C. at a rate of 5° C. a minute.

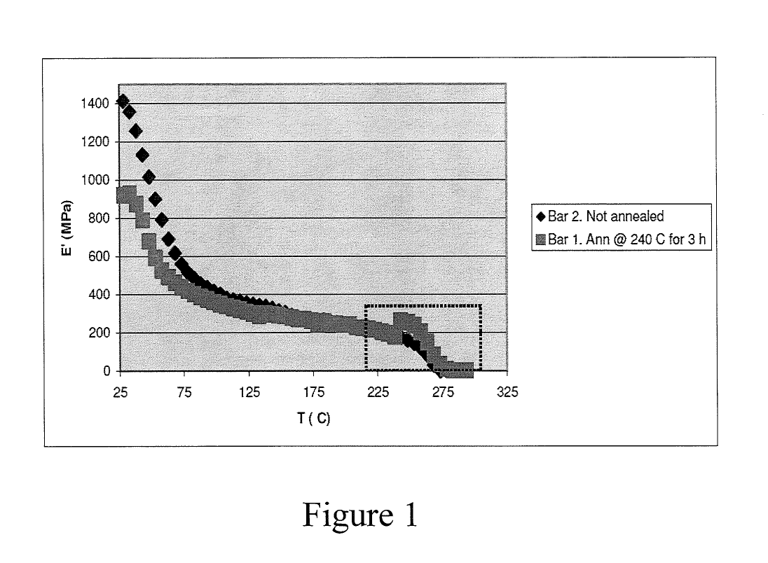

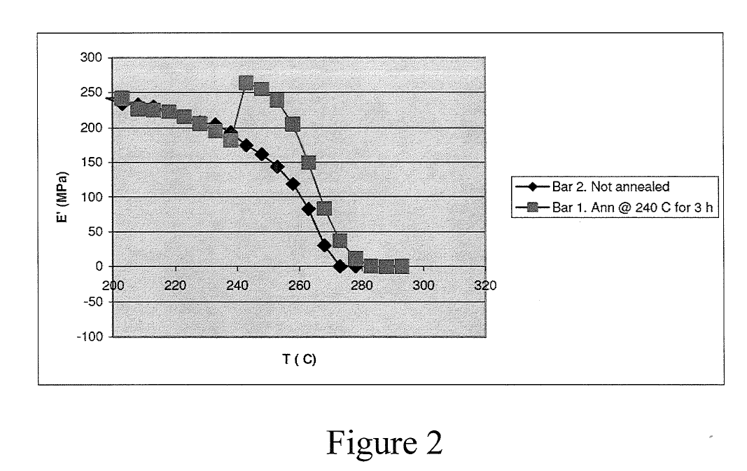

Another molded bar that was not irradiated (hereinafter called Bar 2) was also analyzed via DMTA, but the temperature cycle was different then the one used in the first experiment. The temperature was directly increased from 25 to 300° C., at a rate of 5° C. a minute, without any annealing at 240° C. Storage modulus versus temperature, recorded during the DMTA analyses for Bar 1 and 2 are shown in the FIGS. 1 and 2. FIG. 1 depicts the storage modulus versus temperature measured on a DMTA on both the bars manufactured from the formulation reported in Table 1. The increase in modulus due to annealing at 240° C. can be seen in the FIG. 1 for the Bar 1 over the Bar 2. FIG. 2 shows the enlargement of recorded storage modulus versus temperature corresponding to the area demarcated by the dotted rectangle in the FIG. 1.

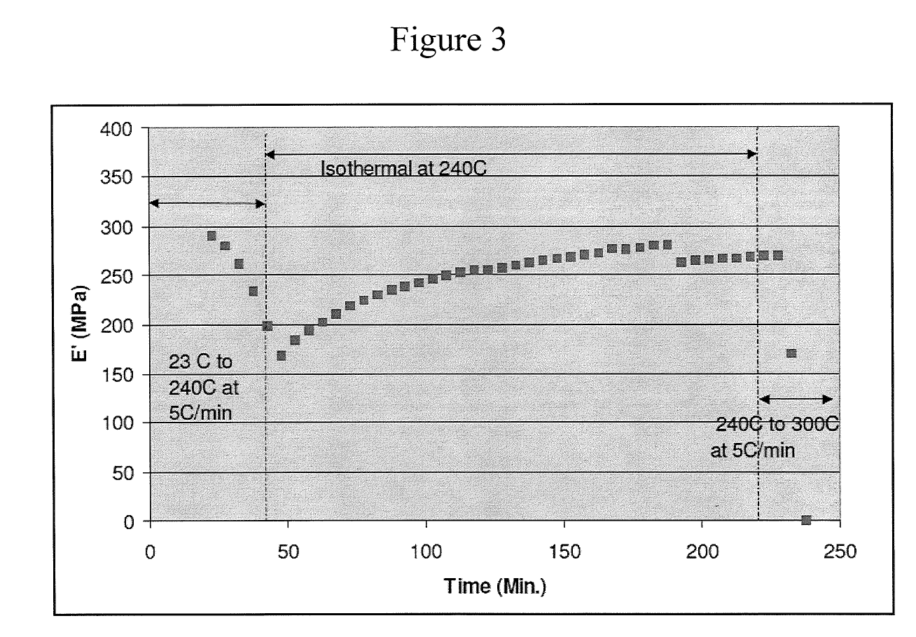

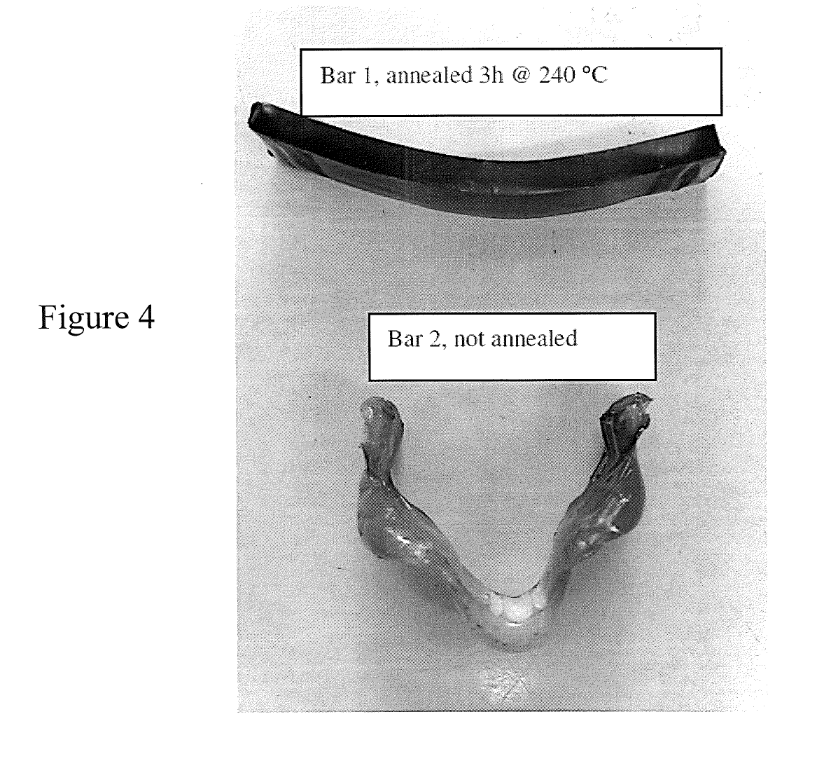

FIG. 3 depicts the storage modulus as a function of time, recorded during the experiment on Bar 1, which is also reported in the FIGS. 1 and 2. FIG. 4 depicts the Bar 1 and Bar 2, after the DMTA experiment described in the paragraphs [0079] [0080], top and bottom respectively. As described in the paragraphs [0079] and [0080], Bar 1 has been annealed at 240° C. for 3 hours, while Bar 2 was not annealed. As is apparent from the FIG. 4, Bar 1 is slightly deformed by the bending force exerted during the DMTA experiment while Bar 2, which was not annealed, is drastically deformed.

From the FIGS. 1-4, it can be seen that there is an increase in storage modulus in Bar 1 that has been annealed to 240° C. This increase is clearly visible in the FIG. 3, where the storage modulus of Bar 1 is reported as function of time. The annealing at 240° C. for Bar 1 causes a steady increase in storage modulus due to the crosslinking, while the heating directly to 300° C. for Bar 2 does not promote as much crosslinking leading to severe deformation during the DMTA test.

Thus the annealing at 240° C. for 3 hours permits the Bar 1 to undergo gradual crosslinking, which in turn permits it to maintain dimensional stability while at elevated temperatures (300° C.). On the other hand, the Bar 2, which was not permitted to gradually crosslink was not able to withstand the temperature of 300° C. without undergoing substantial deformation.

An increase in modulus during annealing for 3 h at 240° C. indicated that PA66 has been thermally crosslinked during annealing due to the presence of TAIC, without the need for irradiation. When the sample was directly heated up to 300° C., as in the case of Bar 2, there is no sufficient time to obtain a cross-linked network, therefore the modulus does not increase and the bar undergoes to a remarkably dramatic deformation when compared with Bar 1. The final percentage of TAIC after the DMTA was also checked. Bar 1 and Bar 2 showed a percentage of TAIC of 0.81 and 0.61 wt % respectively. Since the initial amount of TAIC in the molded bars, before DMTA experiments was 1.63 wt %, it means that in both cases more then 50% wt of the TAIC reacted due to temperature increase during the DMTA scan. However since Bar 1 was annealed at 240° C., there was sufficient time to form a crosslinking network, while in the case of Bar 2 the TAIC has and/or partially evaporated and/or reacted but the proper crosslinking network was not formed.

### Example 2

This example was conducted to demonstrate the difference between two formulations—Formulation I and II, where Formulation I contains a crosslinking agent, while Formulation II contains no crosslinking agent. The respective formulations are shown in the Table 2.

TABLE 2
Formulation

| I (wt %) | II (wt %) |
|---|---|
| 21.7% polyamide 6 | 52.9% polyamide 6,6 |
| (DOMANID 24) | (DOMANID 24) |
| 19.7% polyamide 6,6 | |
| (STABAMID 24AE1) | |
| 5% TAIC | |
| 30% Glass Fiber EC 10 | 25.5% Glass Fiber EC 10 |
| 23% EXOLIT OP 1312 | 21% EXOLIT OP 1312 |
| 0.25% Irganox 1098 | 0.25% Irganox 1098 |
| 0.15% Irgafos 168 | 0.15% Irgafos 168 |
| 0.25% Aluminum Stearate | 0.25% Aluminum Stearate |

Formulation I and II differ in the sense that Formulation II is based on 52.9 wt % polyamide 6,6 whereas Formulation I contains a 41.4% polyamide 6/polyamide 6,6 blend in a weight ratio of 52:48. The glass fiber loading in Formulation I is 30%, while in Formulation II it is 25.5 wt %. The flame retardant used in both formulations was EXOLIT OP1312. The flame retardant levels were substantially similar (23 and 21 wt % for Formulations I and II respectively). Stabilization packages are identical.

The Formulation I and II were subjected to aging in a hot air oven at different temperatures. Samples were taken out at regular intervals and evaluated for their tensile strength.

For polyamides, thermo-oxidative degradation results in a decrease in molecular mass, accompanied by a decrease in physical and mechanical properties (Ref.: Pagilagan, R. U., “Nylon Plastics Handbook”, Kohan, M. I. (Ed.), p.58; Hanser, Munich, 1995). So, in oven aging, one would expect a decrease in tensile properties with time. Furthermore, when comparing aging at different temperatures, the time to reach 50% retention in tensile properties would decrease upon increasing the aging temperature.

Although there are some differences in the Formulations I and II, it is not expected that there would be large differences in thermal oxidative aging behavior. Polyamide 6,6 in general shows somewhat higher thermal oxidative stability than polyamide 6. Higher glass fiber loading would result to a somewhat improved service life temperature. TAIC is assumed to become reactive on irradiation.

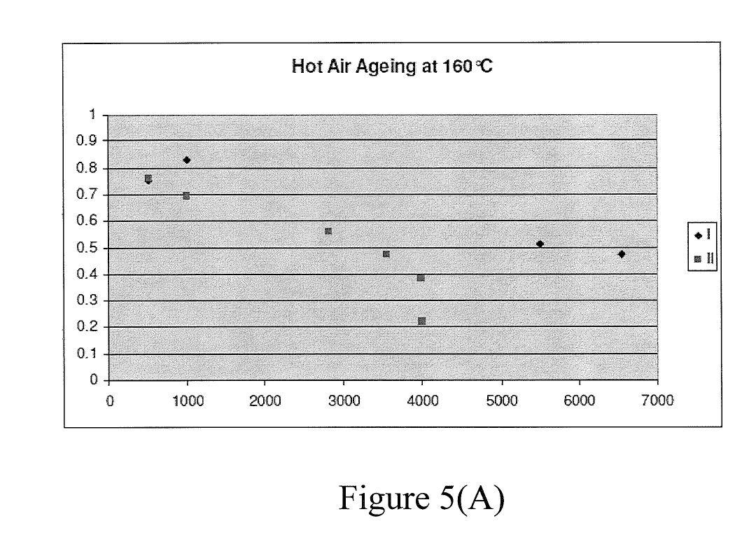

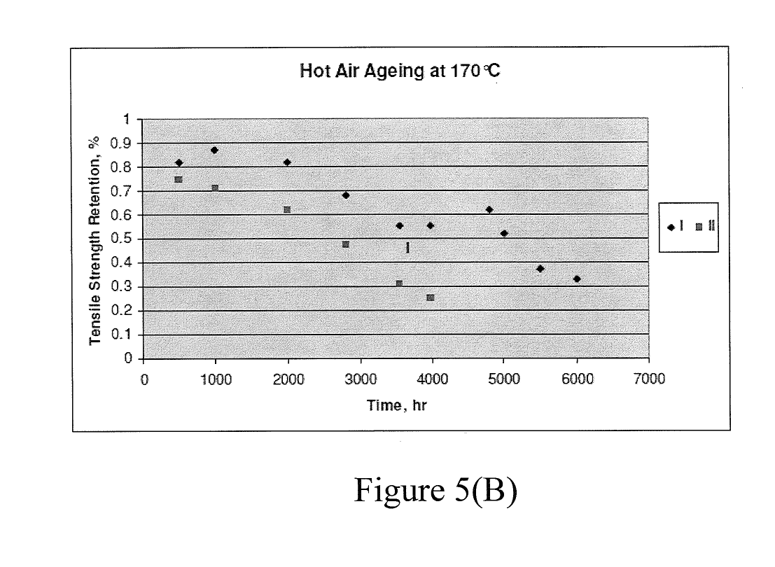

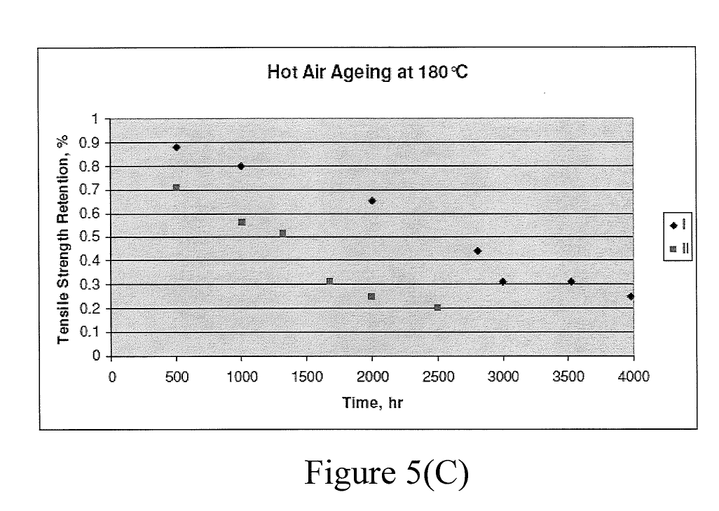

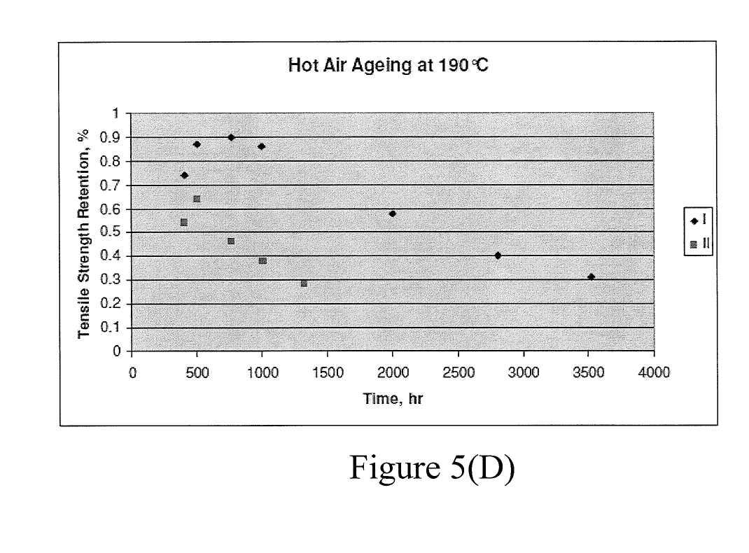

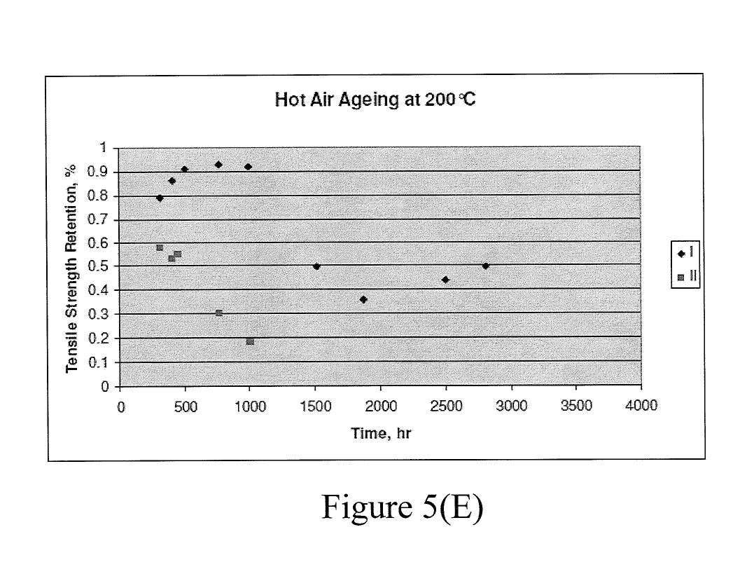

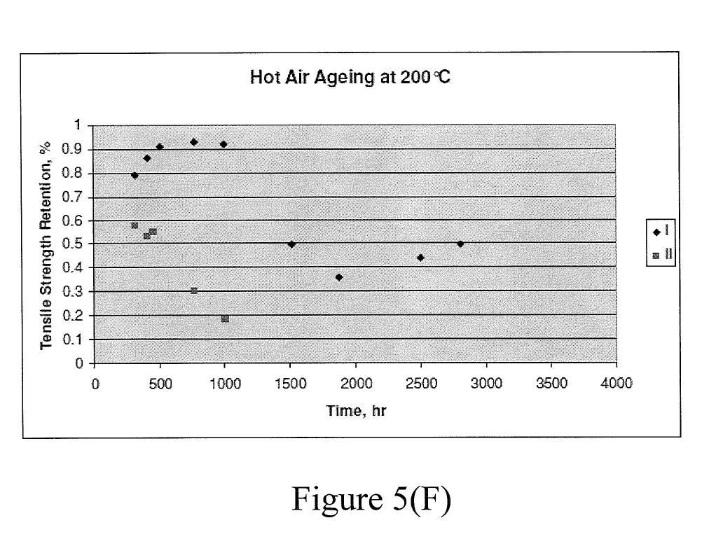

The aging data at temperature in the range of 160 to 210° C. for Formulations I and II are presented in the FIGS. 5A through 5F. An indicator of the thermal oxidative stability can be obtained by the time taken to reach 50% retention in tensile strength. Based on this aging data, the time to reach 50% retention in tensile strength is given in Table 3 for different aging temperatures.

TABLE 3

| | Time (hours) to 50% Tensile Strength Retention | |
|---|---|---|
| Temperature (° C.) | Formulation I | Formulation II |
| 160 | 6000 | 3400 |
| 170 | 5000 | 2700 |
| 180 | 2450 | 1200 |
| 190 | 2450 | 650 |
| 200 | 1500 | 400 |
| 210 | | 300 |

From Table 3, it can be seen that there is a decrease in time to reach 50% retention in tensile strength going from 160 to 180° C. For both Formulation I and II, this decrease is similar: about 20% going from 160° C. to 170° C. (Formulation I: a 17% decrease and Formulation II: a 21% decrease), and about 50% in going from 170° C. to 180° C. (Formulation I: a 51% decrease and Formulation II: a 56% decease). From 190° C. however, a distinct difference in aging behavior is observed. Formulation II degrades further as expected for polyamides. For Formulation I however, one can distinguish different steps upon aging that become more apparent at higher aging temperatures.

A. An initial decrease between time t=0 and the first measure point (312 hour)

B. An increase from 312 to 504 hours.

C. Constant from 504 to 1000 hour, whereby the level of the plateau increase on increasing aging temperature (90% at 190° C., 92% at 200° C. and 100% at 210° C.).

D. Decrease in tensile strength after 1000 hours. For aging at 190° C. this continues throughout the time scale of the measurements (up to 3528 hours). For aging at 200° C. down to about 35% after which it increases again (E.) and at 210° C. the minimum reached is only 60%.

E. Increase for 200° C. and 210° C. whereby the higher the temperature, the higher the tensile strength retention (71% at 210° C. against 50% at 200° C. at the last measure point, i.e., 2808 hour).

The above aging behavior for sample I indicates initial decrease in molecular mass (A), but at temperatures from 190° C. on crosslinking starts to become a dominant factor (B), in competition with molecular mass decrease as result of thermal oxidative degradation (D & E).

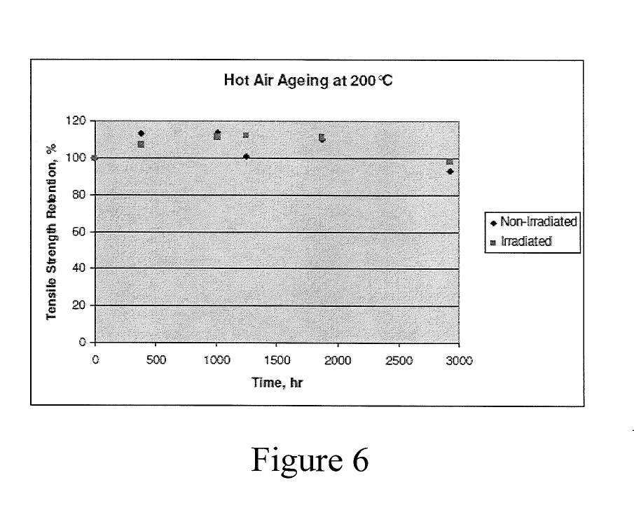

In another set of experiments, a Formulation III (a black version of Formulation I) was compared in thermal oxidative stability, non-irradiated and e-beam irradiated (105 kiloGray) (FIG. 6). FIG. 6 is a graph showing the hot air aging at 200° C. for Formulation III when e-beam irradiated and non-irradiated.

Over a period of 3000 hours, no change in aging is seen between irradiated and non-irradiated samples. Furthermore, both samples show for the first 2000 hours, tensile strength values higher than that of the non-aged sample. This and the fact that tensile strength retention for both Formulations I and III after nearly 3000 hours is still greater than 90% demonstrates the role of crosslinking.

The fact that the aging behavior of Formulations I and III-non-irradiated differ could be related to a variation in TAIC level due to its volatility under melt processing conditions and/or due to an intrinsic measurement error. The above results demonstrate the unexpected when a TAIC crosslinking agent is present in polyamides: high level of crosslinking can be obtained with TAIC whereby it is NOT needed to crosslink via e-beam irradiation, but by simply exposing samples to temperatures >190° C., whereby the higher the temperature, the more pronounced the crosslinking. This creates a method that can be used to induce thermal oxidative stability during usage at elevated temperatures or as a built-in feature for self-reparation on high temperature exposure.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. An article comprising:
a thermoplastic composition; and
a crosslinking agent; the crosslinking agent being thermally activated by annealing at a temperature proximate to the flow point of the thermoplastic composition to stabilize the high temperature mechanical properties and/or dimensions of the article when compared with the high temperature mechanical properties and/or dimensions of a similar article that contains the thermoplastic resin without the crosslinking agent.

2. The article of claim 1, where the annealing occurs during service due to service conditions.

3. The article of claim 1, where the service comprises frictional service, electrical service, exposure to electromagnetic radiation, exposure to heat, or a combination thereof.

4. The article of claim 1, where the thermoplastic composition comprises a thermoplastic organic polymer.

5. The article of claim 4, where the thermoplastic organic polymer is a homopolymer, a copolymer, a block copolymer, an alternating copolymer, an alternating block copolymer, a random copolymer, a random block copolymer, a graft copolymer, a star block copolymer, an ionomer, a dendrimer, or a combination comprising at least one of the foregoing polymers.

6. The article of claim 4, where the thermoplastic organic polymer is a polyamide.

7. The article of claim 1, where the flow point is the glass transition temperature of the thermoplastic composition.

8. The article of claim 1, where the flow point is the melting temperature of the thermoplastic composition.

9. The article of claim 1, where the flow point is between the glass transition temperature and the melting temperature of the thermoplastic composition.

10. The article of claim 4, where the thermoplastic organic polymer is a polyacetal, a polyolefin, a polyacrylic, a polycarbonate, a polystyrene, a polyester, a polyamide, a polyamideimide, a polyarylate, a polyarylsulfone, a polyethersulfone, a polyphenylene sulfide, a polyvinyl chloride, a polysulfone, a polyimide, a polyetherimide, a polytetrafluoroethylene, a polyetherketone, a polyether etherketone, a polyether ketone ketone, a polybenzoxazole, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, a polysilazane, a polytetrafluoroethylene, a fluorinated ethylene propylene, a perfluoroalkoxyethylene, a polychlorotrifluoroethylene, a polyvinylidene fluoride, a polysiloxane, a phenolic resin, or a combination comprising at least one of the foregoing thermoplastic organic polymers.

11. The article of claim 1, where the crosslinking agent comprises two or more unsaturated groups.

12. The article of claim 1, where the crosslinking agent comprises an acryloyl, methacryloyl, vinyl or allyl groups.

13. The article of claim 1, where the crosslinking agent comprises a 1,3,5-triazine derivative.

14. The article of claim 1, where the crosslinking agent comprises a triazine, where the triazines are 1,3,5-triazine, 2,4,6-tris(2-propenyloxy), 1,3,5-triazine-2,4,6(1H,3H,5H)-trione, 1,3,5-tri-2-propenyl, 1,3,5-tris-(2methyl-propenyl)-s-triazine-2,4,6(1H,3H,5H)-trione, or a combination comprising at least one of the foregoing triazines.

15. The article of claim 1, where the crosslinking agent is an isocyanate crosslinking agent, a polyaldehyde crosslinking agent, a phosphine crosslinking agent, an epoxy crosslinking agent, a triazine crosslinking agent, a phosphine crosslinking agent, or a combination comprising at least one of the foregoing crosslinking agents.

16. An article comprising:
a thermoplastic composition; and
a crosslinking agent; the crosslinking agent being thermally activated during service by increasing the temperature of the article to a temperature of greater than or equal to about 100° C. above the flow point of the thermoplastic composition for a time period of less than or equal to about 20 minutes.

17. The article of claim 16, where the service is defined as use in a particular application.

18. The article of claim 16, where the service comprises frictional service, electrical service, exposure to electromagnetic radiation, exposure to heat, or a combination thereof.

19. The article of claim 16, where the thermoplastic composition comprises a thermoplastic organic polymer.

20. The article of claim 19, where the thermoplastic organic polymer is a polyamide.

21. The article of claim 16, where the flow point is between the glass transition temperature and the melting temperature of the thermoplastic composition.

22. The article of claim 20, where the thermoplastic organic polymer is a polyacetal, a polyolefin, a polyacrylic, a polycarbonate, a polystyrene, a polyester, a polyamide, a polyamideimide, a polyarylate, a polyarylsulfone, a polyethersulfone, a polyphenylene sulfide, a polyvinyl chloride, a polysulfone, a polyimide, a polyetherimide, a polytetrafluoroethylene, a polyetherketone, a polyether etherketone, a polyether ketone ketone, a polybenzoxazole, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, a polysilazane, a polytetrafluoroethylene, a fluorinated ethylene propylene, a perfluoroalkoxyethylene, a polychlorotrifluoroethylene, a polyvinylidene fluoride, a polysiloxane, a phenolic resin, or a combination comprising at least one of the foregoing thermoplastic organic polymers.

23. The article of claim 16, where the crosslinking agent comprises two or more unsaturated groups.

24. The article of claim 16, where the crosslinking agent comprises an acryloyl, methacryloyl, vinyl or allyl groups.

25. The article of claim 16, where the crosslinking agent comprises a 1,3,5-triazine derivative.

26. The article of claim 16, where the crosslinking agent comprises a triazine, where the triazines are 1,3,5-triazine, 2,4,6-tris(2-propenyloxy), 1,3,5-triazine-2,4,6(1H,3H,5H)-trione, 1,3,5-tri-2-propenyl, 1,3,5-tris-(2methyl-propenyl)-s-triazine-2,4,6(1H,3H,5H)-trione, or a combination comprising at least one of the foregoing triazines.

27. The article of claim 16, where the crosslinking agent is an isocyanate crosslinking agent, a polyaldehyde crosslinking agent, a phosphine crosslinking agent, an epoxy crosslinking agent, a triazine crosslinking agent, a phosphine crosslinking agent, or a combination comprising at least one of the foregoing crosslinking agents.

28. A method comprising:
manufacturing an article comprising:
a thermoplastic composition; and
a crosslinking agent;
placing the article in service;
increasing the temperature of the article; and
crosslinking the article only in those regions where the temperature exceeds an activation temperature for the crosslinking agent.

29. The method of claim 28, where the step of increasing the temperature of the article occurs after the article has been placed into service and wherein the service comprises frictional service, exposure to electromagnetic radiation that heats the article to facilitate crosslinking, electrical service, service that includes thermal conduction or convection, or a combination comprising at least one of the foregoing forms of service.

30. The method of claim 28, where the step of increasing the temperature of the article occurs before the article has been placed into service.

31. The method of claim 28, where the activation temperature is proximate to the flow point of the thermoplastic composition.

32. The method of claim 31, where the flow point is the glass transition temperature of the thermoplastic composition.

33. The method of claim 31, where the flow point is the melting point of the thermoplastic composition.
